(19) United States
(12) Patent Application Publication
(10) Pub. No.: US 2022/0305506 A1
(43) Pub. Date: Sep. 29, 2022

(54) ROTARY ATOMIZATION PAINTING DEVICE AND ROTATION BALANCE ADJUSTING METHOD

(71) Applicant: HONDA MOTOR CO., LTD., Tokyo (JP)

(72) Inventor: Osamu YASHIMA, Tokyo (JP)

(21) Appl. No.: 17/678,032

(22) Filed: Feb. 23, 2022

(30) Foreign Application Priority Data
Mar. 26, 2021 (CN) 202110323488.1

(51) Int. Cl. B05B 5/04; B05B 3/10

(52) U.S. Cl. CPC B05B 5/0407; B05B 3/1014; B05B 3/1035; B05B 3/1064

(57) ABSTRACT

Provided is a rotary atomization painting device that can adjust balance in a state in which a bell cup and an inner member are integrally assembled and can achieve an increase in yield and a reduction in the number of manufacturing steps. A rotary atomization painting device including a rotary atomizer head configured to rotate to atomize paint, the rotary atomizer head having: a bell cup that is formed into a bell shape to cause paint to be formed into a thin film; and an inner member that is arranged inside the bell cup and forms a paint reservoir, the inner member having a plurality of weight mounts on which weights are selectively mountable.

This application is based on and claims the benefit of priority from Chinese Patent Application No. 202110323488.1, filed on 26 Mar. 2021, the content of which is incorporated herein by reference.

### BACKGROUND OF THE INVENTION

### Field of the Invention

The present invention relates to a rotary atomization painting device and a rotation balance adjusting method.

### Related Art

A rotary atomization painting device has been conventionally known as a painting device used for painting automobile bodies and the like. The rotary atomization painting device uses a bell cup and atomizes paint by means of a centrifugal force to apply paint. Since the bell cup rotates at a speed of tens of thousands of rpm using an air motor, an allowable dynamic balance value is set. This value is generally adjusted by cutting machining a balance correction portion of the bell cup, to fall within an allowable range. On the other hand, there is proposed a rotary atomization painting device in which a rotary atomizer head includes an inner member forming a paint reservoir and an outer member forming a paint film thinning surface, and these members are connected independently to a rotating shaft (see Patent Document 1).
Patent Document 1: Japanese Patent No. 6113569

### SUMMARY OF THE INVENTION

In the conventional rotary atomization painting devices, the balance correction portion of the bell cup is cutting machined, but cutting machining allowance is insufficient in some cases, which may cause breakage of the member, resulting in decrease in yield. On the other hand, in the device disclosed in Patent Document 1, the bell cup and the inner member are independently manufactured, and then are assembled to each other to rotate in an integrated state. Therefore, it is necessary to machine them in the integrated state again to adjust rotation balance. This may cause an increase in the number of steps in the manufacturing process.

The present invention has been devised in view of the circumstances described above, and an object thereof is to provide a rotary atomization painting device that can adjust balance in a state in which a bell cup and an inner member are integrally assembled and can achieve an increase in yield and a reduction in the number of manufacturing steps, and a rotation balance adjusting method for the rotary atomization painting device.

(1) A rotary atomization painting device (e.g., a rotary atomization painting device 1, which will be described later) including a rotary atomizer head (e.g., a rotary atomizer head 2, which will be described later) configured to rotate to atomize paint, the rotary atomizer head including: a bell cup (e.g., a bell cup 3, which will be described later) that is bell-shaped and configured to form paint into a thin film; and an inner member (e.g., an inner member 4, which will be described later) that is provided inside the bell cup and forms a paint reservoir (e.g., a paint reservoir 7, which will be described later), the inner member having a plurality of weight mounts (e.g., weight mounts 21, which will be described later) on which weights (e.g., a weight 22, which will be described later) are selectively mountable.

(2) The rotary atomization painting device according to the above-described (1), wherein the bell cup has: a small diameter side opening (e.g., a small diameter side opening 5, which will be described later) that is attached to a rotation shaft (e.g., a rotation shaft 8, which will be described later) and through which paint is to be supplied from a predetermined paint supply source; and a large diameter side opening (e.g., a large diameter side opening 6, which will be described later) configured to release a thin film of the paint, and the weight mounts are provided on a surface of the inner member, the surface facing the small diameter side opening.

(3) The rotary atomization painting device according to the above-described (2), wherein a feed tube (e.g., a feed tube 18, which will be described later) to which paint is to be supplied from the paint supply source is provided inside the rotation shaft, a surface (e.g., a rear surface 24, which will be described later) of the inner member has a paint inlet (e.g., a paint inlet 19, which will be described later) through which the feed tube is to be inserted, the surface facing the small diameter side opening, and the weight mounts are provided outward of the paint inlet.

(4) The rotary atomization painting device according to any one of the above-described (1) to (3), wherein the weight are arranged coaxially with the rotation center of the rotary atomizing head.

(5) The rotary atomization painting device according to any one of the above-described (1) to (4), wherein the weight has a male thread on an outer circumference of the weight, and the weight mount has a thread hole having an inner surface provided with a female thread, the female thread being configured to engage the male thread of the weight.

(6) A rotation balance adjusting method for a rotary atomizer head (e.g., a rotary atomizer head 2, which will be described later) including: a bell cup (e.g., a bell cup 3, which will be described later) that is bell-shaped and configured to form paint into a thin film; and an inner member (e.g., an inner member 4, which will be described later) that is provided inside the bell cup and forms a paint reservoir (e.g., a paint reservoir 7, which will be described later), the method including: a weight mounting step (e.g., a weight mounting step S1, which will be described later) of mounting weights on the inner member; a fixing step (e.g., a fixing step S2, which will be described later) of fixing, to an inside of the bell cup, the inner member on which the weights are mounted in the weight mounting step; a balance measuring step (e.g., a balance measuring step S3, which will be described later) of measuring rotation balance of the rotary atomizer head in which the inner member is fixed to the inside of the bell cup; and a balance adjusting step (e.g., a balance adjusting step S4, which will be described later) of adjusting the position in which the weights are mounted based on a result of measurement of the rotation balance.

In the rotary atomization painting device of (1), the rotation balance of the rotary atomizer head can be adjusted by selectively mounting the weights on the weight mounts in the state in which the bell cup and the inner member are integrally assembled. This can provide the rotary atomization painting device that can achieve an increase in yield and a reduction in the number of manufacturing steps.

In the rotary atomization painting device of (2), the weight mounts are positioned off a flow of paint, whereby defects can be prevented from being formed on a painted film surface, the defects being caused by releasing a paint residue resulting from the paint adhering to the weight and caking up, to the painted surface.

In the rotary atomization painting device of (3), the weight mounts are positioned outside the paint inlet, whereby the paint can be prevented from adhering to the weights, which makes it possible to suppress difficulty in detaching and attaching the weights due to sticking of the paint, and suppress generation of the paint residue.

In the rotary atomization painting device of (4), a plurality of weight is arranged coaxially with the rotation center of the rotary atomizing head, whereby the rotation balance can be easily adjusted.

In the rotary atomization painting device of (5), a thread is used for the weight, whereby the weight can be easily detached and attached, and fixed.

In the rotation balance adjusting method of (6), the balance can be adjusted by mounting the weights on the inner member to enable the balance adjusting, which makes it possible to adjust the rotation balance of the entire rotary atomizer head in which the inner member and the bell cup are integrated.

### BRIEF DESCRIPTION OF THE DRAWINGS

FIG. 1 is a cross-sectional view illustrating a configuration of a distal end of a rotary atomization painting device as an embodiment of the present invention;

FIG. 2 is an enlarged cross-sectional view of an inner member of the rotary atomization painting device of FIG. 1;

FIG. 3 is a rear view of the inner member of the rotary atomization painting device of FIG. 1; and

FIG. 4 is a flow diagram illustrating a method of adjusting rotation balance of a rotary atomizer head according to an embodiment of the present invention.

### DETAILED DESCRIPTION OF THE INVENTION

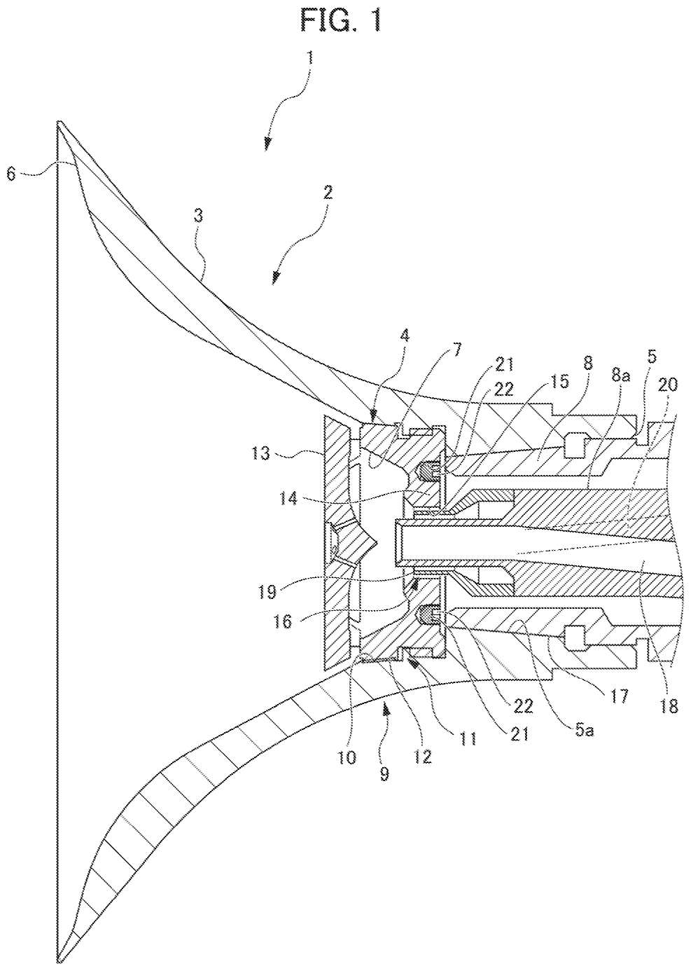

Hereinafter, an embodiment of the present invention will be described with reference to the drawings. FIG. 1 is a cross-sectional view illustrating a configuration around a rotary atomizer head of a rotary atomization painting device as an embodiment of the present invention. Specifically, FIG. 1 is a cross-sectional view illustrating a bell cup 3 forming a rotary atomizer head 2 and a portion of an inner member 4 along a rotational axial direction, in a rotary atomization painting device 1. The bell cup 3 is bell-shaped, in which the inner diameter and outer diameter thereof increase gradually and continuously from a small diameter side opening 5 on a proximal side (on the right side in FIG. 1) to a large diameter side opening 6 on a distal end side (on the left side in FIG. 1) along the rotational axial direction.

The inner member 4 having a substantially cylindrical shape is attached coaxially with the bell cup 3 inside the small diameter side opening 5 of the bell cup 3. The inner member 4 has a void space therein, the void space serving as a paint reservoir 7. The bell cup 3 is attached, on the small diameter side opening 5 side, to a hollow rotation shaft 8 shared with a virtual rotational axis.

The bell cup 3 is joined to the inner member 4 by joining an inner peripheral joint portion 10 to an outer peripheral joint portion 12, the inner peripheral joint portion 10 serving as an inner peripheral portion of a proximal side small diameter portion 9 having a diameter substantially the same as the diameter of the small diameter side opening 5, the outer peripheral joint portion 12 being provided in an outer circumference of a middle cylindrical portion 11 at a middle portion in the axial direction of the inner member 4.

The inner member 4 has the above-described paint reservoir 7 formed to be surrounded by a front disk 13 on the distal end side in the axial direction, a rear disk 14 on a rear end side in the axial direction, and an inner peripheral surface of the middle cylindrical portion 11. A casing (not illustrated) is provided around the outer circumference of the bell cup 3. The casing is provided with an ejection port through which shaping air is to be ejected substantially toward the distal end side in the axial direction.

An insertion hole 15 extending in the axial direction is provided in a center portion of the rear disk 14. A small diameter portion 16 on the distal end side of the rotation shaft 8 is inserted into the insertion hole 15 toward the distal end side in the axial direction, and a distal end of a pipe member 8a in the rotation shaft 8 is open toward the paint reservoir 7 in the inner member 4. The inner member 4 is attached to the rotation shaft 8 through the bell cup 3 by coupling an attached portion 5a in an inner peripheral surface on the small diameter side opening 5 side of the bell cup 3 to an annular attaching portion 17 in an outer peripheral surface in the vicinity of the distal end of the rotation shaft 8.

Inside the rotating shaft 8, the pipe member 8a is arranged coaxially with the rotating shaft 8. A feed tube 18 is provided inside the pipe member 8a, the feed tube 18 serving as a supply passage of paint to be supplied from a paint supply source (not illustrated). The insertion hole 15 positioned at a center of a surface in the inner member 4, the surface facing the small diameter side opening 5 in the bell cup 3, functions as a paint inlet 19 through which the feed tube 18 of the pipe member 8a passes. A sub feed tube 20 is provided, as a branch passage, inside the rotation shaft 8, the sub feed tube 20 having a pipe port shared with the feed tube 18 and serving as a supply flow passage of a cleaning fluid. The feed tube 18 and sub feed tube 20 extend to the distal end of the rotation shaft 8 to communicate with the paint reservoir 7 of the inner member 4. Note that a gap is provided between the inner peripheral surface of the insertion hole 15 functioning as the paint inlet 19 and the outer peripheral surface of the distal end of the pipe member 8a, so that the pipe member 8a does not rotate whether the inner member 4 and/or the bell cup 3 rotates or not.

The inner member 4 is provided with a plurality (e.g., 16) of weight mounts 21 arranged at regular intervals in the circumferential direction at positions on the outer circumference of the insertion hole 15 in the rear disk 14, i.e., at positions outside the paint inlet 19, in a surface in the rear disk 14, the surface facing the small diameter side opening 5 in the bell cup 3. The arrangement of the weight mounting portion 21 in the circumferential direction is coaxial with the rotation center of the rotary atomizing head 2. Each of the weight mounts 21 has a thread hole in which a female thread is formed on an inner surface of the thread hole, the female thread being configured to engage a male thread formed on an outer circumference of a weight 22 to be selectively mounted on the weight mount 21.

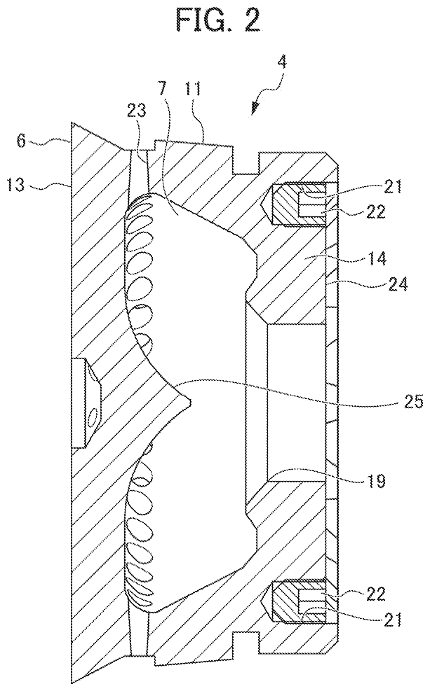

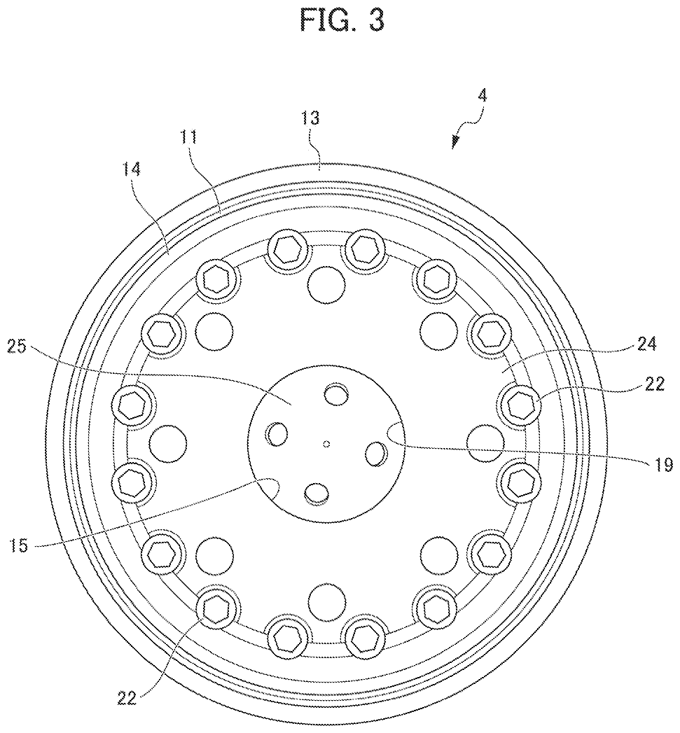

FIG. 2 is an enlarged cross-sectional view of the inner member 4 of the rotary atomization painting device 1 of FIG. 1. FIG. 3 is a rear view of the inner member 4 of the rotary atomization painting device 1 of FIG. 1. In FIGS. 2 and 3, components corresponding to those illustrated in FIG. 1 are denoted by the same reference numerals, and the description provided above with reference to FIG. 1 applies to the individually corresponding components illustrated in FIGS. 2 and 3 as appropriate.

The inner member 4 has the paint reservoir 7 formed to be surrounded by the front disk 13, the rear disk 14, and the middle cylindrical portion 11 therein. A plurality of paint discharge holes 23 are provided in a boundary portion between the middle cylindrical portion 11 and the front disk 13, the plurality of paint discharge holes 23 radially communicating from the paint reservoir 7 to the outside of the inner member 4. The plurality of paint discharge holes 23 are arranged at regular intervals along the outer circumference of the inner member 4.

As is apparent with reference to FIG. 3, the plurality of weights 22 mounted on the weight mounts 21 are arranged at regular intervals in the circumferential direction at respective positions outside the paint inlet 19 in a rear surface 24 of the rear disk 14. In rear view of FIG. 3, a flow guide cone 25 is observed in the insertion hole 15 functioning as the paint inlet 19, the flow guide cone 25 provided at a center of a rear surface of the front disk 13.

All of the plurality of weight mounts 21 arranged at regular intervals in the circumferential direction are arranged at positions avoiding the paint flow. Therefore, there is no possibility that paint flowing in a supply path adheres to the weights 22 mounted on the weight mounts 21.

When the paint is applied using the rotary atomization painting device 1 described with reference to FIGS. 1 to 3, the rotation shaft 8 is driven to rotate at a high speed of, for example about 20,000 rpm by an air motor (not illustrated). This enables the inner member 4 and the bell cup 3 to rotate at the high speed. A high voltage is applied to the rotation shaft 8.

At this time, the inner member 4 and the bell cup 3 being in electrical communication with the rotation shaft 8 has the same electric potential as that of the rotation shaft 8. The paint is supplied to the paint reservoir 7 of the inner member 4 through the feed tube 18 in the pipe member 8a. The paint in the paint reservoir 7 is radially ejected from the paint discharge holes 23 by means of a centrifugal force due to high speed rotation of the inner member 4.

The paint ejected from the paint discharge holes 23 is formed into a thin film to be thinner as it gradually propagates over a paint diffusing surface (surface) toward the large diameter side, the paint diffusing surface serving as an inner peripheral surface having a diameter expanding toward the distal end side in the axial direction of the bell cup 3 rotating at a high speed, and then is released from the large diameter side opening 6. The released paint is applied to a target workpiece by a potential difference from the high voltage applied as described above, and electrostatic painting is performed.

Since the inner member 4 rotates at a high speed, it is necessary to adjust rotation balance with high accuracy. In the present embodiment, the adjustment is performed by selectively mounting the weights 22 on the plurality of weight mounts 21 provided to be arranged at regular intervals circumferentially on the rear disk 14 of the inner member 4.

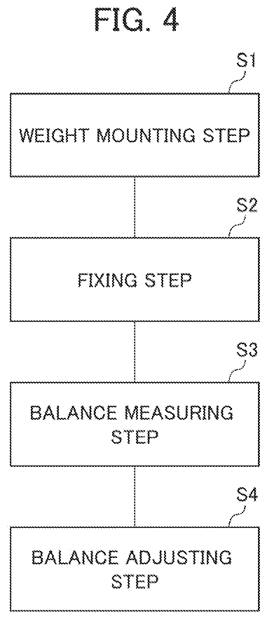

FIG. 4 is a flow diagram illustrating a method of adjusting rotation balance of the rotary atomizer head 2 according to an embodiment of the present invention. As described above, the rotary atomizer head 2 includes the bell cup 3, and the inner member 4 having the paint reservoir 7 arranged inside the bell cup 3. The method of adjusting the rotation balance of the rotary atomizer head 2 will be described with reference to FIG. 4. First, the weights 22 are mounted on the weight mounts 21 of the inner member 4. This step is referred to as a weight mounting step S1.

Next, the inner member 4 in which the weights 22 are mounted on the weight mounts 21 in the weight mounting step S1 is fixed to the inside of the bell cup 3. This step is referred to as a fixing step S2.

Next, the bell cup 3 in the state in which the inner member 4 in which the weights 22 are mounted on the weight mounts 21 is fixed to the inside of the bell cup 3 in the fixing step S2 is placed on a balance measurement device to measure the rotation balance of the rotary atomizer head 2 (a portion of the bell cup 3 to which the inner member 4 is attached). This step of making the measurement is referred to as a balance measuring step S3. As the balance measurement device used in the balance measuring step S3, general devices configured to apply the rotation to an object to be measured to output and display deviation of the balance can be used.

Next, the mounting forms of the weights 22 mounted on the weight mounts 21 are adjusted based on the balance measurement result obtained in the balance measuring step S3. Specifically, the balance is adjusted by removing the weight 22 mounted on the weight mount 21 at an angular position corresponding to unbalance based on the data including an amount of run-out and an unbalance angle of an object to be measured by the balance measurement device, the run-out and unbalance angle being caused by rotation of the object to be measured. This step of performing the adjustment is referred to as a balance adjusting step S4. The balance measuring step S3 and the balance adjusting step S4 are repeated as required.

According to the rotary atomization painting device and the rotation balance adjusting method of the present embodiment, the following effects can be obtained.

A rotary atomization painting device 1 of (1) is a rotary atomization painting device 1 including a rotary atomizer head 2 configured to rotate to atomize paint, the rotary atomizer head 2 having a bell cup 3 that is bell-shaped and configured to form paint into a thin film, and an inner member 4 that is provided inside the bell cup 3 and forms a paint reservoir 7, the inner member 4 having a plurality of weight mounts 21 on which weights 22 are selectively mountable. Therefore, the rotation balance of the rotary atomizer head 2 can be adjusted by selectively mounting the weights 22 on the weight mounts 21 in the state in which the bell cup 3 and the inner member 4 are integrally assembled. This can substantialize the rotary atomization painting device that can achieve an increase in yield and a reduction in the number of manufacturing steps.

In the rotary atomization painting device 1 of (2), the bell cup 3 has: a small diameter side opening 5 that is attached to a rotation shaft 8 and through which paint is to be supplied from a predetermined paint supply source; and a large diameter side opening 6 configured to release a thin film of the paint, and the weight mounts 21 are provided on a surface of the inner member 4, the surface facing the small diameter side opening 5. As a result, the weight mounts 21 are positioned off a flow passage of paint, whereby defects can be prevented from being formed on a painted film surface, the defects being caused by releasing a paint residue resulting from the paint adhering to the weight 22 and caking up, to the painted surface.

In the rotary atomization painting device 1 of (3), a feed tube 18 to which paint is to be supplied from the paint supply source is arranged inside the rotation shaft 8, and the rear surface 24 of the inner member 4 has a paint inlet 19 through which the feed tube 18 is to be inserted, the rear surface 24 facing the small diameter side opening 5, and the weight mounts 21 are provided outward of the paint inlet 19. Therefore, the weight mounts 21 are positioned outside the paint inlet, whereby the paint can be prevented from adhering to the weights 22, which makes it possible to suppress difficulty in detaching and attaching the weights 22 due to sticking of the paint, and suppress generation of the paint residue.

In the rotary atomization painting device 1 of (4), the weight mounting portion 21 is arranged coaxially with the rotation center of the rotary atomizing head 2. Therefore, the rotation balance of the rotary atomizer head 2 can be easily adjusted.

In the rotary atomization painting device 1 of (5), the weight 22 has a male thread formed on an outer circumference of the weight 22, and the weight mount 21 has a female thread formed on an inner surface of the weight mount 21, the female thread being configured to engage the male thread of the weight 22. As a result, the weight 22 can be easily detached from and attached to, and fixed to the weight mount 21.

A rotation balance adjusting method of (6) is a rotation balance adjusting method for a rotary atomizer head 2 including a bell cup 3 that is bell-shaped and configured to form paint into a thin film, and an inner member 4 that is provided inside the bell cup 3 and forms a paint reservoir 7, the method including: a weight mounting step S1 of mounting weights 22 on the inner member 4; a fixing step S2 of fixing, to an inside of the bell cup 3, the inner member 4 on which the weights 22 are mounted in the weight mounting step S1; a balance measuring step S3 of measuring rotation balance of the rotary atomizer head 2 in which the inner member 4 is fixed to the inside of the bell cup 3; and a balance adjusting step S4 of adjusting the position in which the weights 22 are mounted based on the result of measurement of the rotation balance. This makes it possible to adjust the rotation balance of the entire rotary atomizer head 2 in which the inner member 4 and the bell cup 3 are integrated.

In the foregoing, the embodiment of the present invention has been described, but the present invention is not limited to the above embodiment. The configuration of the specifics may be modified as appropriate, without deviating from the spirit of the present invention. For example, in the above-described embodiment, a configuration is adopted in which a male thread type weight is screwed into a weight mount provided with an internally threaded hole cut the female thread, but alternatively, a plurality of weights being platy small pieces having the same shape, the same dimensions and the same mass may be selectively fixed, by separate screw or the like, to the weight mounts set in a circumferential band-like state on the outer circumferential side of the paint inlet 19. Also in this case, the rotation balance of the rotary atomizer head can be adjusted by selectively mounting the weights on the weight mounts.

### EXPLANATION OF REFERENCE NUMERALS

1 Rotary atomization painting device
2 Rotary atomizer head
3 Bell cup
4 Inner member
5 Small diameter side opening
5a Attached portion
6 Large diameter side opening
7 Paint reservoir
8 Rotation shaft
8a Pipe member
9 Proximal side small diameter portion
10 Inner peripheral joint portion
11 Middle cylindrical portion
12 Outer peripheral joint portion
13 Front disk
14 Rear disk
15 Insertion hole
16 Small diameter portion
17 Attaching portion
18 Feed tube
19 Paint inlet
20 Sub feed tube
21 Weight mount
22 Weight
23 Paint discharge hole
24 Rear surface
25 Flow guide cone

What is claimed is:

1. A rotary atomization painting device comprising a rotary atomizer head configured to rotate to atomize paint,
the rotary atomizer head comprising:
a bell cup that is bell-shaped and configured to form paint into a thin film; and
an inner member that is provided inside the bell cup and forms a paint reservoir,
the inner member having a plurality of weight mounts on which weights are selectively mountable.

2. The rotary atomization painting device according to claim 1, wherein
the bell cup has:
a small diameter side opening that is attached to a rotation shaft and through which paint is to be supplied from a predetermined paint supply source; and
a large diameter side opening configured to release a thin film of the paint, and
the weight mounts are provided on a surface of the inner member, the surface facing the small diameter side opening.

3. The rotary atomization painting device according to claim 1, wherein
the bell cup has:
a small diameter side opening that is attached to a rotation shaft and through which paint is to be supplied from a predetermined paint supply source; and
a large diameter side opening configured to release a thin film of the paint,
the weight mounts are provided on a surface of the inner member, the surface facing the small diameter side opening, and
a feed tube to which paint is to be supplied from the paint supply source is provided inside the rotation shaft,
a surface of the inner member has a paint inlet through which the feed tube is to be inserted, the surface facing the small diameter side opening, and
the weight mounts are provided outward of the paint inlet.

4. The rotary atomization painting device according to claim 1, wherein
the weight are arranged coaxially with the rotation center of the rotary atomizing head.

5. The rotary atomization painting device according to claim 1, wherein
the weight has a male thread on an outer circumference of the weight, and
the weight mount has a thread hole having an inner surface provided with a female thread, the female thread being configured to engage the male thread of the weight.

6. A rotation balance adjusting method for a rotary atomizer head comprising:
a bell cup that is bell-shaped and configured to form paint into a thin film; and an inner member that is provided inside the bell cup and forms a paint reservoir, the method comprising:
a weight mounting step of mounting weights on the inner member;
a fixing step of fixing, to an inside of the bell cup, the inner member on which the weights are mounted in the weight mounting step;
a balance measuring step of measuring rotation balance of the rotary atomizer head in which the inner member is fixed to the inside of the bell cup; and
a balance adjusting step of adjusting a position in which the weights are mounted based on a result of measurement of the rotation balance.
